(19) United States
(12) Patent Application Publication
(10) Pub. No.: US 2023/0016368 A1
(43) Pub. Date: Jan. 19, 2023

(54) ACCELERATING INFERENCES PERFORMED BY ENSEMBLE MODELS OF BASE LEARNERS

(71) Applicant: INTERNATIONAL BUSINESS MACHINES CORPORATION, ARMONK, NY (US)

(72) Inventors: Jan Van Lunteren, Ruschlikon (CH); Charalampos Pozidis, Thalwil (CH)

(21) Appl. No.: 17/376,223

(22) Filed: Jul. 15, 2021

(51) Int. Cl. G06N 5/00; G06N 20/20; G06F 9/50; G06F 9/48

(52) U.S. Cl. CPC G06N 5/003; G06N 20/20; G06F 9/5027; G06F 9/4881

(57) ABSTRACT

A method is provided for accelerating machine learning inferences. The method uses an ensemble model run on input data. This ensemble model involves several base learners, where each of the base learners has been trained. The method first schedules tasks for execution. As a result of the task scheduling, one of the base learners is executed based on a subset of the input data. The execution of the tasks is then started to obtain respective task outcomes. An exit condition is repeatedly evaluated while executing the tasks by computing a deterministic function of the task outcomes obtained so far. This deterministic function output values indicate whether an inference result of the ensemble model has converged. Accordingly, the execution of the tasks can be interrupted if the exit condition evaluated last is found to be fulfilled. Eventually, an inference result of the ensemble model is estimated based on the task outcomes.

### BACKGROUND

The present invention relates in general to the field of computerized methods and computer program products for accelerating machine learning inferences. In particular, it is directed to methods of accelerating inferences performed by an ensemble model of base learners, where tasks scheduled for the base learners are interrupted as soon as it can be determined, based on the output values of the base learners, that the tasks have likely converged.

Decision tree learning is a predictive modelling approach used in machine learning. It relies on one or more decision trees, forming the predictive model. Decision trees are widely used machine learning algorithms, owing to their simplicity and interpretability. Different types of decision trees are known, including classification trees and regression trees. A binary decision tree is a structure involving coupled decision processes. Starting from the root, a feature is evaluated, and one of the two branches of the root node is selected. This procedure is repeated until a leaf node is reached, a value of which is used to assemble a final result.

Random forest and gradient boosting are important machine learning methods, which are based on binary decision trees. In such methods, multiple decision trees are “walked” in parallel until leaf nodes are reached. The results taken from the leaf nodes are then averaged (regression) or used in a majority vote (classification). Such computations can be time and resource consuming, hence a need to accelerating inferences, notably for random forest and gradient boosting methods. The same conclusion extends to ensemble models of any type of base learners.

### SUMMARY

According to one aspect, the present invention is embodied as a computer-implemented method of accelerating machine learning inferences. The context assumed is that an ensemble model is to be run on input data. This ensemble model involves several base learners, where each of the base learners is assumed to have already been trained. I.e., each of the base learners is a trained learner, ready for performing machine-learning inferences. The method first schedules tasks for execution. For each of the scheduled tasks, one of the base learners is to be executed based on at least a subset of the input data. The execution of the scheduled tasks is then started, with a view to obtain respective task outcomes. Still, an exit condition is repeatedly evaluated while executing the scheduled tasks, e.g., upon completing each tasks (or groups of tasks). This exit condition is evaluated by computing a deterministic function of the task outcomes obtained so far. This deterministic function is devised in such a manner that its output values indicate whether an inference result of the ensemble model has converged. Accordingly, the execution of the scheduled tasks can be interrupted if the exit condition evaluated last is found to be fulfilled. Eventually, the inference result of the ensemble model is estimated based on the obtained task outcomes.

According to another aspect, the invention is embodied as a computer program product for accelerating machine learning inferences. The computer program product comprises a computer readable storage medium having program instructions embodied therewith. The program instructions are executable by processing means of a computerized system to cause the processing means to perform steps according to the above methods.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 schematically illustrates an ensemble model of base learners, which are assumed to be binary decision trees in this example, according to at least one embodiment;

FIG. 2 illustrates a binary decision tree as involved in the ensemble model of FIG. 1, according to at least one embodiment;

FIG. 3 shows a selection of connected nodes of the decision tree of FIG. 2, together with feature identifiers and threshold values of the nodes as used to execute such nodes, according to at least one embodiment;

FIG. 4 is a flowchart illustrating high-level steps of a method of determining a suitable threshold value, which is used to determine whether the ensemble model has converged, according to at least one embodiment;

FIG. 5 is a flowchart illustrating high-level steps of a computer-implemented method of accelerating the execution of the ensemble model by interrupting tasks scheduled for the base learners as soon as it is determined, based on output values of the base learners, that the tasks have likely converged, according to at least one embodiment;

FIGS. 6A-F depicts plots of histories of outputs of a summation function of outputs of individual base learners (here decision trees) of an ensemble model of 100 leaners run on different input data. Such histories can be used to determine a threshold value according to the method steps shown in FIG. 4, according to at least one embodiment; and

FIG. 7 schematically represents a general purpose computerized system, suited for implementing one or more method steps as involved in embodiments of the invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Accelerating inferences performed by an ensemble model can basically be achieved by speeding up (i) the individual base learner processing, (ii) the parallel processing of multiple base learners, and/or (iii) the way the processing results are handled. This invention focuses on the third approach, although embodiments address or concern the first and the second approach as well. Essentially, the present inventors have realized that it is possible to accelerate inferences performed by an ensemble model of base learners by interrupting tasks scheduled for the base learners as soon as it can be determined, based on output values of the base learners, that the tasks have likely converged. They have accordingly devised novel methods and computer program products, which are described below.

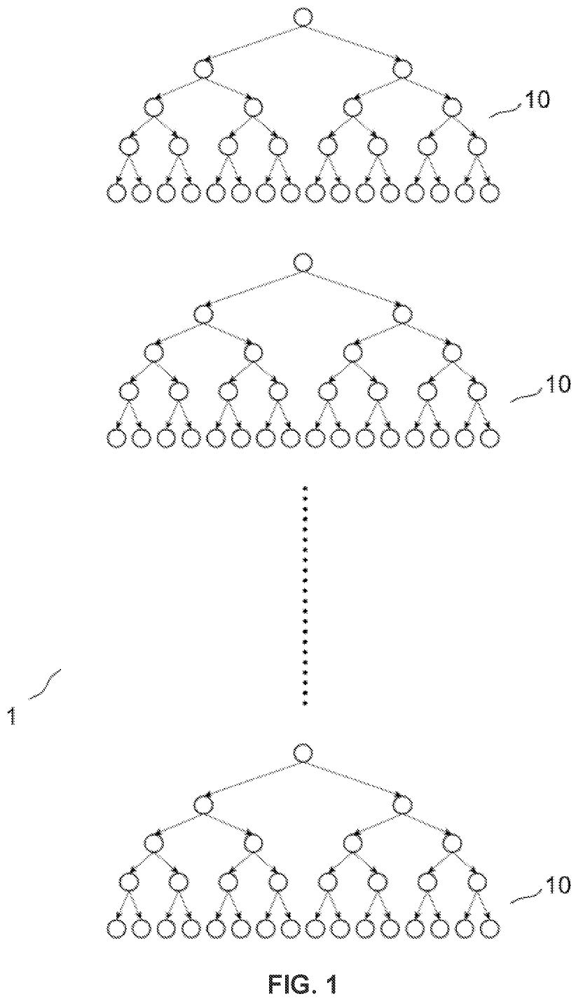

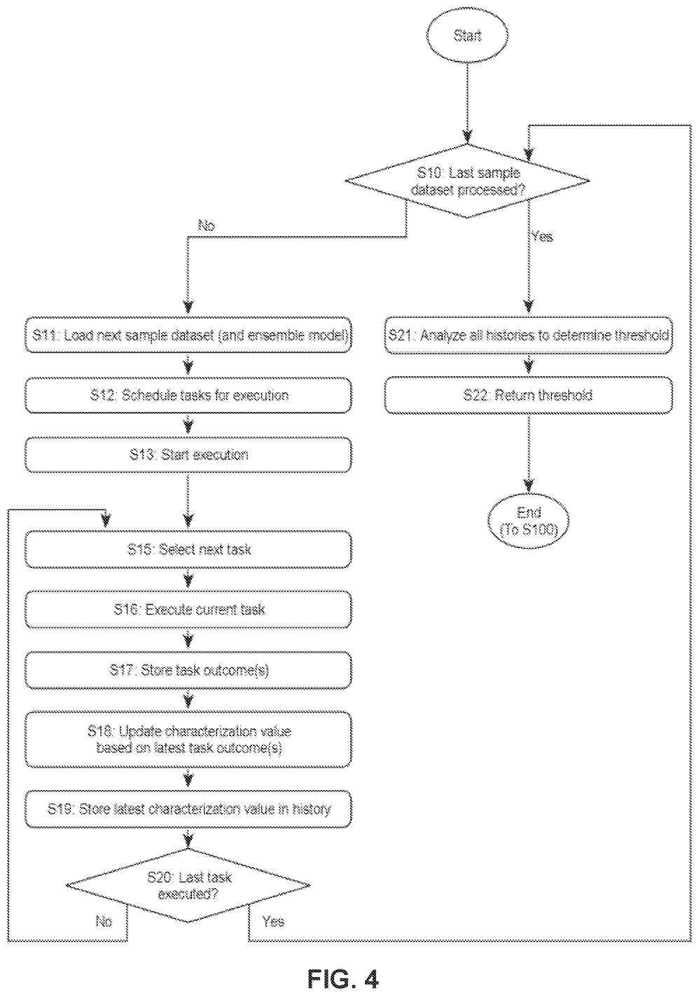

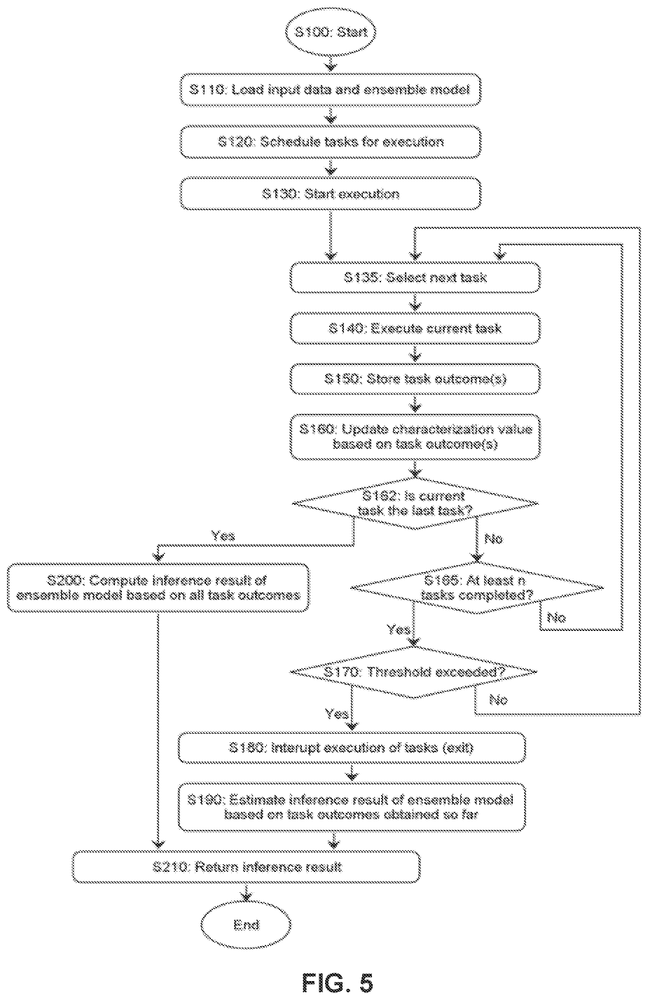

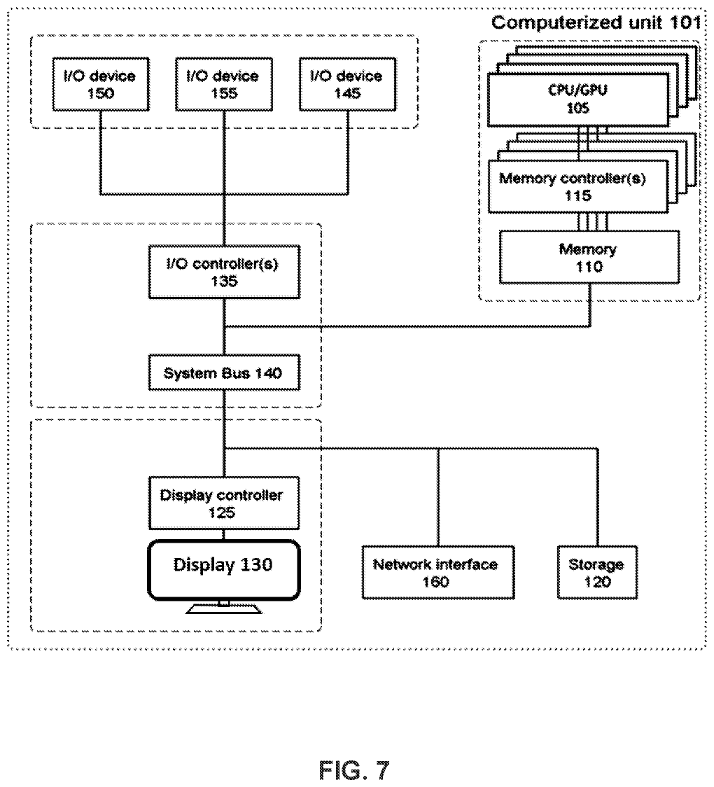

An aspect of the invention is now discussed in reference to FIGS. 1-3, and 5. This aspect concerns a computer-implemented method of accelerating machine learning inferences. Note, this method and its variants are collectively referred to as the “present methods” in this document. All references Sn refer to methods steps of the flowcharts of FIGS. 4 and 5, while numeral references pertain to mathematical concepts, physical parts, and components of the system shown in FIG. 7.

This method relies on an ensemble model 1 involving several base learners, such as binary decision trees. The ensemble model may for instance be a random forest model or a gradient boosting model, as known per se. FIG. 1 schematically illustrates such an ensemble model, which involves several decision trees 100. Each base learner is assumed to have already been trained, such that the ensemble model 1 is ready to perform inferences. To that aim, input data are accessed (step S110 in FIG. 5) and fed to the ensemble model 1, as usual.

Tasks are subsequently scheduled for execution at step S120, see FIG. 5. That is, each base learner is scheduled to run on part or all of the input data, in order to eventually form an ensemble result. Note, the base learners of the ensemble model 1 are meant to be executed on a same input dataset or subsets of this dataset. Thus, a same learner (or a same type of learners) may possibly be run on different subsets of the input dataset. In other words, for each of the scheduled tasks, one of the base learners is to be executed based on at least a subset of the input data.

The execution of the scheduled tasks is subsequently started, at step S130, with a view to obtain respective task outcomes. However, as per the present invention, not all of the tasks will necessarily need to be performed. I.e., the tasks will be interrupted as soon as it can be established that a convergence has manifestly been reached.

To that aim, an exit condition is repeatedly evaluated (at steps S160-S170) while executing the scheduled tasks. That is, this exit condition may be evaluated upon completing a task, or a group of tasks, or at time intervals. The exit condition serves to determine a point in time from which the tasks can be interrupted. In the present case, the exit condition is evaluated by computing S160 a deterministic function of the task outcomes as obtained so far (i.e., before the exit condition is fulfilled). This function is devised in such a manner that its output values indicate (or can be used to determine) whether an inference result of the ensemble model 1 has likely converged. This function can typically be represented as an analytic function, e.g., involving a summation over the task outcomes, as discussed later in detail.

The evaluation of this exit condition works as a post-test loop, i.e., as a do-while loop, such that at least one tasks is first performed, and then additional tasks execute, or are interrupted, depending on the evaluation of the exit condition. In practice, the exit condition can be devised to ensure that at least a predetermined number (or fraction) of the tasks have completed. However, the deterministic function is normally computed at least once before completing the execution of all the tasks.

If the exit condition evaluated last is found to be fulfilled (step S165: Yes, and step S170: Yes), then the execution of the scheduled tasks is interrupted at step S180. The inference result of the ensemble model 1 is subsequently estimated (step S190) based on the task outcomes as obtained so far. Note, if, for a given input dataset, the exit condition happens to never be fulfilled, then the tasks are all performed, such that the inference result will eventually be computed (step S200) based on all the task outcomes obtained.

The present approach differs from classical convergence at training, insofar as the proposed method concerns convergence achieved during inference operations, where the convergence is tested based on intermediate results (i.e., outputs from the base learners) obtained while executing the scheduled tasks. That is, the proposed method provides a way of adaptively varying the number of learners (or, at least, the number of tasks scheduled) run on input data during the inference phase. A foremost advantage of this approach is that it does require completing all the tasks, given that the convergence may be determined to have been achieved earlier. Another advantage is that this approach allows a tradeoff to be achieved between prediction accuracy and prediction speed, without modifying the trained learners at all. I.e., the method may set one or more parameters impacting the evaluation of the exit condition, e.g., based on user inputs. Thus, the present methods can easily be implemented with known ensemble techniques.

The embodiments discussed herein mostly focus on ensemble models involving binary decision trees, which are used for binary classification purposes, for the sake of illustration. However, the present concepts are not limited to binary decision trees. That is, any base learner may be contemplated, in principle. For input records for which it can be determined, early on, that the overall ensemble result has converged, the number of tasks to be executed can be reduced.

All this is now described in detail, in reference to particular embodiments of the invention. To start with, the tasks scheduled S120 for execution may advantageously be grouped into disjoint subsets of tasks, where such subsets are formed so as to allow vector processing techniques to be leveraged. Each subset typically comprises a same number of tasks. Accordingly, the tasks of each subset can be executed S130-S140 in parallel, using vector processing. In particular, the proposed scheme advantageously supports vector-processing for decision trees. For example, multiple instances of a same decision tree 100 may possibly be executed based on distinct sets of input data, in parallel, using vector processing. In other cases, a same input dataset may be processed in parallel by distinct base learners. Because of the simple processing steps required by decision tree nodes, processing multiple trees can be done in parallel using vector instructions. More generally, vector processing capabilities of state-of-the-art central processing units (CPUs) can advantageously be exploited to accelerate the processing of multiple learners in parallel. Beyond CPUs, however, the proposed scheme is further applicable to various inference platforms, including Field-Programmable Gate Arrays (FPGAs).

In embodiments, the deterministic function is computed S160 upon completing each of the subsets of the tasks, or upon completing some of the subsets of the tasks. However, this function is preferably computed based on all the task outcomes available at the moment when the function is computed, taking into account all of the available task outcomes, so as to produce one output per task. Thus, the function is computed in blocks, i.e., for multiple tasks at a time. In other words, the deterministic function is computed S160 upon completing each of successive ones of the subsets of the tasks, it being noted that successive subsets are not necessarily consecutive (i.e., immediately contiguous), though based on all the available task outcomes.

In embodiments where the tasks are not grouped into subsets, the deterministic function may possibly be computed upon completing each consecutive task. In variants, the function is not systematically computed upon completing each and every task. Rather, the function is computed at intervals, e.g., upon completion of each cycle of m tasks or at time intervals, in the interest of efficiency. Again, this function is preferably computed based on all the task outcomes available, so as to produce one output per task.

As noted earlier, the exit condition is preferably devised so as to make sure that a minimal number n (or fraction f) of the tasks will be executed, prior to interrupting the tasks. That is, a first necessary condition is that the exit condition can only be fulfilled (step S165: Yes) if at least a predetermined number or a fraction of the tasks have completed. In that case, the deterministic function is computed upon completing each task (or subset of tasks, or at intervals) but is not computed prior to completing a predetermined number or a fraction of the tasks. Imposing a minimal number or fraction of the tasks provides some statistical certainty before interrupting the tasks.

The deterministic function may for instance be repeatedly computed S160 to obtain, each time, a current characterization value of the inference result, i.e., a value characterizing the extent to which the inference result has likely converged. In fact, this characterization value may already be an estimation of this inference result, as discussed later in detail.

Next, the characterization value obtained can be compared S170 to one or more reference values, in order to obtain a comparison outcome. This comparison outcome determines (or contributes to determining) the antecedent of the exit condition, i.e., the test to be performed for evaluating this condition.

For example, each base learner may be designed to produce output values restricted to a same range of output values. This means that the learners produce results that are distributed in a same interval, which is especially useful for classification purposes. This interval may for example decomposes into sub-intervals, where, e.g., output values in [0; 1[ correspond to a first class, values in [1; 2[ correspond to second class, etc. In that case, the base learners preferably consist of decision trees. In the following, each base learner is assumed to be a binary decision tree, i.e., a decision tree wherein each node has at most two child nodes. Furthermore, a binary classification may be sought, whereby the decision tree ensemble is to produce one of two possible output values.

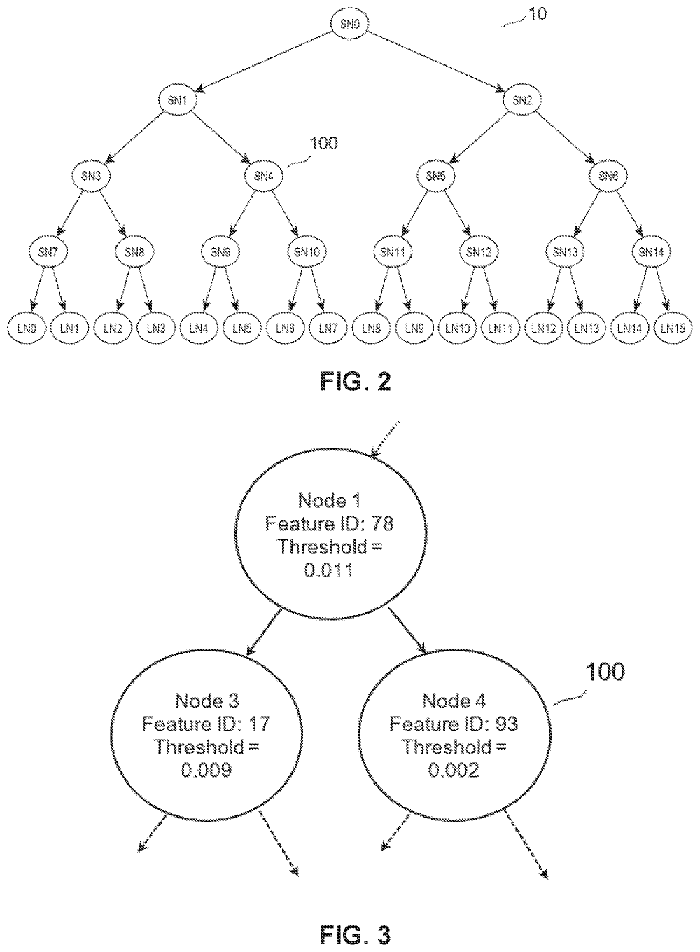

In that respect, FIG. 1 schematically illustrates an ensemble model 1 of several binary decision trees 10, where the decision trees typically differ (be it in structure and/or parametrization), notwithstanding the depiction in FIG. 1. FIG. 2 shows an example of a (small) binary decision tree 10. The nodes 100 include split nodes and leaf nodes. The split nodes are denoted by references SN0 (corresponding to the root node) to SN14, while the leaf nodes are denoted by references LN0 to LN15. Each node is associated with attributes, i.e., operands required to execute the nodes, in operation. Such attributes may for instance include feature identifiers (also called feature selectors) and thresholds used for comparisons. More generally, the node attributes include all arguments needed for evaluating the rules captured by the decision tree nodes. In particular, each split node is labelled with a feature identifier and is associated with a threshold to perform an operation, whereby, for example, a feature value corresponding to a feature identifier is compared to a threshold, as known per se. This is illustrated in FIG. 3, which depicts selected nodes 100 of the tree 10 of FIG. 2, together with respective feature identifier values (“feature ID”) and threshold values.

Using binary decision trees may be advantageous because individual trees are easily trained and efficiently computed for inferences. In addition, relying on binary classifications allows simple heuristics to be devised, in order to determine whether the ensemble model has already converged, as now explained in detail.

In particular, applications to binary classifications allow the deterministic function to be essentially devised as a mere summation, which may be easily and efficiently computed at runtime. That is, in embodiments, the deterministic function involves a summation over the task outcomes as obtained so far. Thus, the function can easily be updated S160 (be it at each step or each interval), in order to update the previously obtained characterization value produced by this function. I.e., a single summand or a few summands need be added to the previous sum each time the function is updated. Next, the inference result can easily be estimated S190 based on the characterization value obtained last. In fact, the sum can, in certain cases, be regarded as an approximation of the inference result, for reasons that will become apparent later.

The deterministic function may notably be devised as an average function, i.e., a function calculating the arithmetic mean (i.e., a weighted summation) of values outputted by the binary decision trees. In that case, the characterization value (as obtained at each step or interval) is an average (or a partial average) of the output values. However, in embodiments, the output values of the binary decision trees may already be suitably scaled (e.g., divided by N, where N is the total number of tasks initially scheduled), or otherwise weighted, such that a mere summation is needed to compute the average. In that case, the characterization value as obtained at each step or interval is simply a sum of the task outcomes obtained so far. Summations can advantageously be used where the decision trees produce scaled or weighted outputs, which further reduces the overhead incurred by the exit condition evaluation.

For example, the two possible output values produced by the binary decision trees may consist of a positive value and a negative value, e.g., +1 and −1. In that case, the reference value used to evaluate the exit condition may consist of a positive constant threshold value, which makes it very easy to evaluate the exit condition. Namely, a second necessary condition for the exit condition evaluated last to be fulfilled (step S170: Yes) is that the absolute value of the characterization value obtained last is larger than the positive constant threshold value.

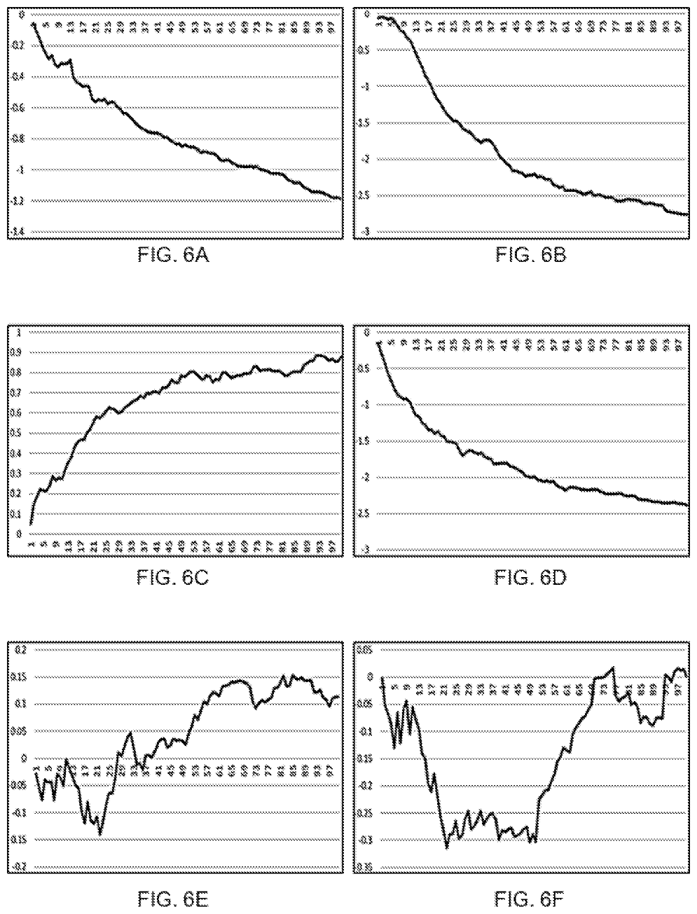

This is now illustrated in reference to FIGS. 6A-F, which aggregates graphs of histories of characterization values as progressively obtained by computing S160 a summation function over outputs of an ensemble model of 100 binary decision trees on 6 distinct input datasets for a binary classification problem. The actual datasets used are unimportant: the graphs only serve to illustrate that various convergence behaviors can potentially be observed, in practice. The convergence toward a negative or positive value is pretty clear and quickly achieved in the examples of FIGS. 6A-6D, while it is more chaotic in the examples of FIGS. 6E and 6F. Still, these examples illustrate that a decisive threshold can fairly easily be identified as value beyond which the ensemble model likely converges. For example, using a threshold t=0.35 is manifestly sufficient to discriminate between quickly converging cases and slowly converging cases. The other way around, using a threshold t=0.35 would have allowed the tasks to be interrupted early on in the examples of FIGS. 6A-6D, when applying the present approach. However, all tasks would have to be performed in the examples of FIGS. 6E and 6F, by construction.

In practice, the summation (or update to the previous sum) performed at step S160 provides an updated characterization value, which is compared to the threshold t at step S170. If the absolute value of the characterization value updated last (step S160) is larger than t, then the current tasks can manifestly be interrupted (step S170: Yes). Interestingly, the inference result can then be estimated S190 based on the value of the characterization value updated last. In fact, because the summation already approximates the inference result in this example, the inference result can be approximated as the characterization value updated last, as noted earlier.

Note, distinct threshold values may possibly be used for positive and negative values, should the calibration tests initially performed suggest doing so. For example, the calibration tests may lead to conclude that a threshold value of +0.5 is necessary to decide on the convergence toward a positive value, while a threshold value of −0.35 may be sufficient to decide whether the model has converged toward a negative value, this depending on the sample cases used for the calibration. In that case, a necessary condition for the exit condition to be fulfilled is that the characterization value obtained last is larger than +0.5 or is smaller than −0.35. Note, the tests performed may involve strict or non-strict inequalities.

Similar heuristics can be devised for non-binary classification: several threshold values may typically be needed in that case. More sophisticated heuristics will typically be required for other types of learners. Having learners designed to produce output values constrained to a determined interval simplifies the heuristics, in practice. In general, the more sophisticated the outputs of the base learners, the more sophisticated the heuristic. Yet, suitable heuristics can still be devised for learners producing multiple values (e.g., output vectors) and/or values that are not constrained to a particular range, as is often the case for application to machine-learning predictions. For example, several sets of threshold values may be used, i.e., one for each output vector element. In other examples, the evaluation of the exit condition may rely on flip moments, or slope of the history curves, etc. As exemplified above, the present approach can be applied to both classification or prediction problems, using decision trees or other types of base learners.

As evoked earlier, some leeway is allowed when setting the reference value(s) used to subsequently evaluate the exit condition when executing the tasks. This way, a tradeoff may be found between prediction accuracy and execution speed. In the example of binary classification, using larger absolute threshold values results in higher accuracy, at the cost of slower execution times.

As illustrated above in reference to FIGS. 6A-F, suitable reference values may be identified by merely inspecting typical histories of the characterization values. In other cases, automated methods or partly-automated methods may be relied on, as now discussed in reference to FIG. 4. That is, the present methods may further comprise preliminary steps aiming at determining S10-S22 suitable reference values. Such reference values may notably be determined by accessing several sample datasets (similar to the datasets used to obtain the history curves shown in FIGS. 6A-6F) and then scheduling S10-S12 preliminary tasks for execution and, this, for each of the sample datasets. Consider a given sample dataset, as loaded at step S11. As with inferences (FIG. 5), for each preliminary task to be performed in respect of this sample dataset, one base learner of the model is to be executed based on at least a subset of the sample data. However, all of the preliminary tasks are here executed S13-S16 to obtain S17 respective outcomes, without interruption. As the preliminary tasks execute, the deterministic function based is repeatedly computed or updated S18 based on the preliminary task outcomes obtained so far. This way, a history of characterization values can be obtained S19, for each sample dataset. Eventually, the various histories are (partly-)automatically analyzed S21, in order to determine S22 suitable reference values. For example, for binary classification purposes, the histories may be analyzed S21 so as to determine S22 one or more threshold values beyond which output values of the deterministic function likely converges.

The determination S21 of the thresholds can be done by determining the value of the output for which no change in the output result would occur in case the execution would be stopped at that moment. The thresholds can also be determined by using a brute-force (or trial-and-error) method, by simply trying a threshold value and then determine the resulting accuracy, which requires another loop. I.e., the threshold value can be automatically incremented, until satisfactory results are obtained. In other approaches, the thresholds are more efficiently determined, e.g., by determining for how many input records the classification results are allowed to flip (from one class to the other), and then setting/updating the thresholds in several steps, checking (at each step) how many results are “flipped”.

A particularly preferred implementation of the preliminary calibration steps is the following. First, a next sample dataset is loaded, as well as the ensemble model (if necessary, i.e., for the first cycle) at step S11. Tasks are then scheduled for execution for the current dataset, at step S12. Execution starts at step S13, whereby a next task is selected, step S15. The current task executes at step S16. The corresponding outcome is stored at step S17, in order to accordingly update the characterization value (as outputted by the deterministic function). The latest characterization value is stored in the history of values pertaining to the current dataset, step S19. At step S20, it is checked whether the current task is the last task to be executed for the current dataset. If so, the method checks S10 whether a further dataset is to be processed. Else, another task is selected S15 for execution, and so on. All sample datasets are similarly processed. Once the last dataset has been processed, step S10, the histories obtained for all the sample datasets are analyzed, in order to determine suitable reference values, e.g., a threshold value, which is returned at step S22. From this moment on, the calibration is over, and the inference phase can start (step S100 in FIG. 5).

As noted above, step S21 can be performed by analyzing history sets of a summation function, i.e., as a function of the number of processed trees (or tasks, given that a same tree may be run on distinct subsets). Based on the recorded histories and a given, target accuracy parameter, the thresholds can then be determined so as to ensure that the desired accuracy is achieved. This target accuracy should, in principle, be at most equal to the actual accuracy achieved for the provided data on the given trained model. Next, methods based on trial-and-error, curve flips, curve slopes, etc., can be employed to determine a suitable threshold. Suitable thresholds can also be determined using a machine learning approach. The training can be adapted (parameters, algorithm) to minimize the average number of trees that need to be processed per input record during inference based on the resulting model (e.g., by influencing “flip characteristics”)

A preferred implementation of the inference acceleration method is the following. The method starts at step S100. At step S110, a given input dataset is loaded, as well as an ensemble model, in view of performing inferences on this dataset. Tasks are scheduled for execution at step S120. Execution starts at step S130, whereby a next task is selected S135 for execution S140. The corresponding outcome is stored at step S150, in order to accordingly update the characterization value by computing the summation or simply updating the previous sum, step S160. At step S162, the method checks whether the last task has completed, in which case it goes to step S200 to compute the inference result based on all task outcomes. If not, it goes to step S165, where it is checked whether a minimal number n (or fraction) of the tasks have already been completed. If not (S165: No), a next task is selected S135 for execution S140. Else, the method checks (S165: Yes) whether the set threshold is exceeded, step S170. Note, the method may be modified to check whether a minimal number of consecutive characterization values exceed this threshold. If so (S170: Yes), both exit conditions are fulfilled, and the execution of the tasks is interrupted at step S180. Then, the inference result is estimated at step S190, based on the sole task outcomes as obtained so far, i.e., before the interruption. The final inference result is returned at step S210, whether estimated S190 based on a partial task outcomes or computed S200 based on all the task outcomes, and the method ends (another input dataset may now be processed, if necessary). Some of the above steps allow parallelization, e.g., using vector processing capabilities of the processing means 105. A speedup factor of 3.6 to 36.4 can typically be obtained, this depending on the target accuracy chosen.

Next, according to another aspect, the invention can be embodied as a computer program product for accelerating machine learning inferences. This computer program product comprises a computer readable storage medium having program instructions embodied therewith, wherein the program instructions are executable by processing means 105 of one or more computerized units 101, see FIG. 7, so as to cause such processing means to perform steps as described earlier in reference to the present methods. In particular, such instructions may cause a computerized unit to leverage vector processing, as discussed earlier.

Computerized systems and devices can be suitably designed for implementing embodiments of the present invention as described herein. In that respect, it can be appreciated that the methods described herein are largely non-interactive and automated. In exemplary embodiments, the methods described herein can be implemented either in an interactive, a partly interactive, or a non-interactive system. The methods described herein can be implemented in software, hardware, or a combination thereof. In exemplary embodiments, the methods proposed herein are implemented in software, as an executable program, the latter executed by suitable digital processing devices. More generally, embodiments of the present invention can be implemented wherein virtual machines and/or general-purpose digital computers, such as personal computers, workstations, etc., are used.

For instance, FIG. 7 schematically represents a computerized unit 101 (e.g., a general- or specific-purpose computer), which may possibly interact with other, similar units, so as to be able to perform steps according to the present methods.

In exemplary embodiments, in terms of hardware architecture, as shown in FIG. 7, each unit 101 includes at least one processor 105, and a memory 110 coupled to a memory controller 115. Several processors (CPUs, and/or GPUs) may possibly be involved in each unit 101. To that aim, each CPU/GPU may be assigned a respective memory controller, as known per se. In variants, controllers of the unit 101 may be coupled to FPGAs, as mentioned earlier. I.e., some of the CPUs/GPUs shown in FIG. 7 may be replaced by FPGAs.

One or more input and/or output (I/O) devices 145, 150, 155 (or peripherals) are communicatively coupled via a local input/output controller 135. The input/output controller 135 can be coupled to or include one or more buses and a system bus 140, as known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processors 105 are hardware devices for executing software instructions. The processors 105 can be any custom made or commercially available processor(s). In general, they may involve any type of semiconductor-based microprocessor (in the form of a microchip or chip set), or generally any device for executing software instructions.

The memory 110 typically includes volatile memory elements (e.g., random-access memory), and may further include nonvolatile memory elements. Moreover, the memory 110 may incorporate electronic, magnetic, optical, and/or other types of storage media.

Software in memory 110 may include one or more separate programs, each of which comprises executable instructions for implementing logical functions. In the example of FIG. 7, instructions loaded in the memory 110 may include instructions arising from the execution of the computerized methods described herein in accordance with exemplary embodiments. The memory 110 may further load a suitable operating system (OS) 111. The OS 111 essentially controls the execution of other computer programs or instructions and provides scheduling, input-output control, file and data management, memory management, and communication control and related services.

Possibly, a conventional keyboard and mouse can be coupled to the input/output controller 135. Other I/O devices 140-155 may be included. The computerized unit 101 can further include a display controller 125 coupled to a display 130. Any computerized unit 101 will typically include a network interface or transceiver 160 for coupling to a network, to enable, in turn, data communication to/from other, external components, e.g., other units 101.

The network transmits and receives data between a given unit 101 and other devices 101. The network may possibly be implemented in a wireless fashion, e.g., using wireless protocols and technologies, such as Wifi, WiMax, etc. The network may notably be a fixed wireless network, a wireless local area network (LAN), a wireless wide area network (WAN), a personal area network (PAN), a virtual private network (VPN), an intranet or other suitable network system and includes equipment for receiving and transmitting signals. Preferably though, this network should allow very fast message passing between the units.

The network can also be an IP-based network for communication between any given unit 101 and any external unit, via a broadband connection. In exemplary embodiments, network can be a managed IP network administered by a service provider. Besides, the network can be a packet-switched network such as a LAN, WAN, Internet network, an Internet of things network, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method of accelerating machine learning inferences, the method comprising:
providing input data and an ensemble model involving several base learners, each of the base learners being a trained learner;
scheduling tasks for execution, whereby, for each of the scheduled tasks, one of the base learners is to be executed based on at least a subset of the input data;
starting an execution of the scheduled tasks with a view to obtain respective task outcomes;
while executing the scheduled tasks, repeatedly evaluating an exit condition by computing a deterministic function of the task outcomes obtained so far, wherein output values of the deterministic function indicate whether an inference result of the ensemble model has converged, and interrupting the execution of the scheduled tasks if the exit condition evaluated last is fulfilled; and
estimating the inference result of the ensemble model based on the obtained task outcomes.

2. The method according to claim 1, wherein, at scheduling the tasks for execution, the tasks are grouped into disjoint subsets of the tasks, whereby, during the execution of the tasks, the tasks of each of the subsets are executed in parallel, using vector processing.

3. The method according to claim 2, wherein the deterministic function is computed upon completing each of successive ones of the subsets of the tasks.

4. The method according to claim 1, wherein the exit condition is devised so that it can only be fulfilled if at least a predetermined number or a fraction of the tasks have been completed.

5. The method according to claim 1, wherein the deterministic function is repeatedly computed to obtain, each time, a characterization value of the inference result, and the characterization value obtained is compared to one or more reference values to obtain a comparison outcome, the latter determining an antecedent of the exit condition.

6. The method according to claim 5, wherein each of the base learners provided is designed to produce output values restricted to a same range of output values.

7. The method according to claim 6, wherein each of the base learners provided is a decision tree.

8. A computer program product for accelerating machine learning inferences, the computer program product comprising a computer readable storage medium having program instructions embodied therewith, the program instructions executable by a processor of a computerized system to cause the processor to:
access input data and an ensemble model involving several base learners, each of the base learners being a trained learner;
schedule tasks for execution, whereby, for each of the scheduled tasks, one of the base learners is to be executed based on at least a subset of the input data;
start an execution of the scheduled tasks with a view to obtain respective task outcomes;
while executing the scheduled tasks, repeatedly evaluate an exit condition by computing a deterministic function of the task outcomes obtained so far, wherein output values of the deterministic function indicate whether an inference result of the ensemble model has converged, and interrupt the execution of the scheduled tasks if the exit condition evaluated last is fulfilled; and
estimate the inference result of the ensemble model based on the obtained task outcomes.

9. The computer program product according to claim 8, wherein the program instructions are further designed to cause the processor to group the tasks scheduled for execution into disjoint subsets of the tasks, so as for the tasks of each of the subsets to execute in parallel, using vector processing, in operation.

10. The computer program product according to claim 9, wherein the deterministic function is computed upon completing each of successive ones of the subsets of the tasks.

11. The computer program product according to claim 8, wherein the exit condition is devised so that it can only be fulfilled if at least a predetermined number or a fraction of the tasks have been completed.

12. The computer program product according to claim 8, wherein the program instructions are further designed to cause the processor to repeatedly compute the deterministic function to obtain, each time, a characterization value of said inference result, and compare the characterization value obtained to one or more reference values to obtain a comparison outcome, the latter determining an antecedent of the exit condition.

13. The computer program product according to claim 12, wherein each of the base learners provided is designed to produce output values restricted to a same range of output values.

14. The computer program product according to claim 13, wherein each of the base learners provided is a decision tree.

15. A computer system for accelerating machine learning inferences, comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
providing input data and an ensemble model involving several base learners, each of the base learners being a trained learner;
scheduling tasks for execution, whereby, for each of the scheduled tasks, one of the base learners is to be executed based on at least a subset of the input data;
starting an execution of the scheduled tasks with a view to obtain respective task outcomes;
while executing the scheduled tasks, repeatedly evaluating an exit condition by computing a deterministic function of the task outcomes obtained so far, wherein output values of the deterministic function indicate whether an inference result of the ensemble model has converged, and interrupting the execution of the scheduled tasks if the exit condition evaluated last is fulfilled; and
estimating the inference result of the ensemble model based on the obtained task outcomes.

16. The computer system according to claim 15, wherein, at scheduling the tasks for execution, the tasks are grouped into disjoint subsets of the tasks, whereby, during the execution of the tasks, the tasks of each of the subsets are executed in parallel, using vector processing.

17. The computer system according to claim 16, wherein the deterministic function is computed upon completing each of successive ones of the subsets of the tasks.

18. The computer system according to claim 15, wherein the exit condition is devised so that it can only be fulfilled if at least a predetermined number or a fraction of the tasks have been completed.

19. The computer system according to claim 15, wherein the deterministic function is repeatedly computed to obtain, each time, a characterization value of the inference result, and the characterization value obtained is compared to one or more reference values to obtain a comparison outcome, the latter determining an antecedent of the exit condition.

20. The computer system according to claim 19, wherein each of the base learners provided is designed to produce output values restricted to a same range of output values.
